(19) United States
(12) Patent Application Publication
(10) Pub. No.: US 2009/0094870 A1
(43) Pub. Date: Apr. 16, 2009

(54) Beverage band

(76) Inventors: Jonathan Isserow, Basking Ridge, NJ (US); Laura Isserow, Basking Ridge, NJ (US)

Correspondence Address: Gearhart Law, LLC, 4 Ferndale Rd., Chatham, NJ, 07928, US

(21) Appl. No.: 11/974,401

(22) Filed: Oct. 12, 2007

(51) Int. Cl. G09F 3/12; G09F 3/00

(52) U.S. Cl. 40/306; 116/278; 116/280

(57) ABSTRACT

The invention provides a unique identifying device that differentiates identical or similar beverage containers. In the case of cans, bottles, boxes, or pouches, a highly preferred band composition is elastic alternated with other material, preferably ribbon that will accept printing or writing. The invention is further a set of such bands, each with its own design, placed around the outside of individual containers to enable users to distinguish their beverage from others that are in the same type of container.

The invention has the advantage of being quick and easy to use, and is inexpensive enough to be disposable. It is an object of the invention to identify individual beverage containers using a unique identifying device.

### FIELD OF THE INVENTION

The invention relates to the field of the identification of individual beverage containers.

### BACKGROUND OF THE INVENTION

The present invention relates to the differentiating of beverage containers in order to differentiate users' drinks. Many social situations involve the serving of beverages in glasses, cups, bottles, cans, boxes or pouches. Typically the glasses, bottles, cans, boxes or pouches in a set will be of the same pattern, making it difficult for different users to determine which drink is theirs once the containers are set down.

This can lead to negative consequences, for instance, the spread of disease when someone drinks from the container that a sick person has been using. Another negative consequence can be an allergic reaction in a person who unwittingly consumes a drink containing a substance to which they're allergic. In a setting where people are gathered and alcohol is served, some patrons may argue or physically fight over a perceived theft of their drink. In an event with children involved, not only are there typically many germs to be spread, but children may get very angry and act inappropriately if another child takes their drink. Additionally, many people are just queasy about sharing germs with anyone. There are attempts to remedy this situation in the prior art, which are listed below.

U.S. Pat. No. 5,927,524 teaches a safety blanket for a baby bottle formed from two very thin flat layers of a liquid impervious material. The two layers of material are sealed around the periphery with the central body portion not attached so as to form a dead air space there between. The two layers are in the general shape of a rectangle with the shorter surface sufficiently sized to reach from top bottom of the bottle height, and the longer dimension sufficient to surround the circumference of the bottle reservoir. A fastening method for attaching the safety blanket around the bottle is provided as is an envelope associated with the fastening method for inserting a substrate with indica thereon.

U.S. Pat. No. 6,412,632 and U.S. Pat. No. 6,508,361 teach a personal identification method and system for improving personal hygiene in which provision is made for identifying a beverage, food product, or the like, with a particular person so that another person does not inadvertently access the identified item unintentionally. Identifying indicia such as numbers or alphabetical letters are selectable and conditioned by the user to be prominently displayed on the item so as to identify it with the individual involved. For necked beverage containers, in one embodiment, a re-usable snap-on display device, or assembly, is configured to snap onto the neck of the container; in another embodiment, the existing conventional cap-attaching ring is modified to include alpha-numeric indicia and/or to receive a cooperating indicia-indicating display element. For beverage cans, a wand-like element portraying selectable alpha-numeric indicia is attached to the conventional snap ring opener; and for boxed beverages, a plurality of selectable identifying apertures are provided so that the user can personally distinguish his or her beverage from those of others.

U.S. Pat. No. 7,243,795 teaches an identification system that distinguishes among a set of individual containers. The identification system has an identifier member associated with each of the containers in the set for facilitating visual discrimination of each of the containers from the others of the set. The identifier member of each container in the set has distinct and visibly different printed identifying indicia positioned over a surface portion of the container, and an opaque covering material covering the printed identifying indicia. The opaque covering material is removable to selectively expose a preselected one of the printed identifying indicia so that during consumption of the contents of the container a user may readily distinguish his container from the other containers in the set by visual inspection of the exposed printed identifying indicia.

U.S. Patent App. No. 2007/0068944 teaches a method of personalizing a beverage bottle which comprises providing a bottle assembly with a side wall having an exterior surface. An array of selectable sleeve wraps are provided, each configured to fit on the side wall of the bottle assembly. Each sleeve wrap has at least one characteristic that is visibly different from the other sleeve wraps of the array. One of the sleeve wraps is selected from the array and attached on the side wall of the bottle assembly.

U.S. Patent App. No. 2005/0223642 teaches a sleeve comprising a lower portion preferably having a base portion and a skirt portion for packaging a floral grouping or plant. The sleeve may have an upper portion which can be detached from the lower portion of the sleeve once the function of the upper portion has been completed. The sleeve has a plurality of horizontally and diagonally positioned expansion elements.

U.S. Patent App. No. 2006/0186129 teaches a storable, reusable-insulating sleeve for a beverage container that provides insulation to the user from hot or cold beverages. The improved sleeve maintains insulation of hot temperatures approximately five and ten degrees higher for a thirty-minute interval, than, for example, cardboard counterpart sleeves. The improved sleeve comprises an integral storage-securing mechanism for storing the sleeve in a compact form. The compact form can easily fit into a pocket, purse, car glove compartment or desk drawer. The sleeve is made of various fabrics and is therefore reusable. Further, a pocket contained in the sleeve will accommodate a prepaid card or a key, for storage, transport and gift giving.

U.S. Patent App. No. 2006/0207132 teaches a system for identifying a specific beverage container among a group of beverage containers. The system can include an elastic band sized for elastically engaging an outer surface of an individual beverage container, and a tag secured to the elastic band. The tag can be removably secured to the elastic band by a clip. The tag can include at least one surface for displaying identifying indicia thereon in such a way as to permit the identifying indicia to be repeatedly changed or altered by a user.

U.S. Patent App. No. 2004/0195254 teaches a flexible composite band to identify an individual drinking container with at least two layers of material and method of manufacture and use are disclosed. The first layer is a flexible layer generally constructed from elastic. The second layer is a decorative layer that can be customized to suit one's tastes and is attached directly to the elastic layer. Once this composite flexible identification band is formed it can be placed around drinking containers of various sizes and shapes and allow for easy identification of a drinking container due to the unique decorative layer.

Co pending U.S. Ser. No. ______ by the current inventors teaches a method of identifying a beverage utilizing either differentiated stirrers or a unique band, however, this application does not teach the article of the present invention.

The present invention has advantages that the prior art lacks. The prior art cites inventions which are more difficult to make and subsequently increase the cost to the consumer. Many of the prior art inventions are specific to a type of container and cannot be used on a variety of different containers. Many of the prior art inventions are meant to be re-usable, whereas the present invention is meant to be disposable, although it can be re-used if desired. The prior art also does not address printing on the band as used for a beverage container identifying device. In the case of patent application 2004/0195254, for instance, the band is manufactured with a design and is not differentiated by printing or writing. U.S. Patent App. No. 2006/0207132 addresses a plastic tag which can be written on with a specific type of pen and then attached to a band on a beverage container, the tag being re-usable. It does not address a printed or band with writing on it. In addition, some inventions cited have uses other than drink differentiation.

One possible solution outside of the present invention and prior art would be to write on the outside of the beverage containers, but this is not generally feasible. In the case of a cocktail party a hostess would not want her glasses defaced, nor would the bar or club owner in their establishment. In the case of disposable containers, many beverage cans and pouches are made from metal or foil, which is difficult to write on. Plastic bottles may weep and erase writing or be difficult to write on initially, and their labels are difficult to write on either because of the material from which they are made or because they are so covered in color and writing that it is difficult to find a place where the writing will show. Glass bottles are difficult to write on as well, and individual beverage boxes are coated with a wax. Finding a writing utensil that may work on any of these surfaces is not always possible, and may not be desirable if young children can access it and write on other surfaces, such as sofas or walls. Writing utensils also are easily misplaced at a party and may be difficult to find, especially in a social situation.

The present invention is quick, easy to use, and relatively inexpensive. It can also add to the festivity of a party in a number of ways, a few of which are listed here. Upon arriving at an event where the device is available, attendees could pick a pattern of their choice, or patterns could be tailored to their professions or other attributes and presented to them at the party. The device could also be identified with a photo that has some meaning to an attendee. The invention could be personalized, so that each person at an event would feel welcomed by finding devices with their name or other meaningful identifier. The invention could contain a joke, so strangers at a gathering could use it as an icebreaker when wishing to speak to someone. A company desiring to host an event and promote its services could use the invention to advertise in a subtle manner. The invention could be used in a game, such that the person with the device containing a certain pattern wins a prize.

The present invention has uses in many different types of social situations. One venue in which the invention is particularly useful is at cookouts, cocktail or other parties, where people are drinking alcoholic beverages (many times out of glasses or bottles) and may need a reminder which drink is theirs, especially if they set it down next to other drinks. Another situation that would benefit from the invention is a crowded bar or club, where people may put their bottles or glasses down in order to dance or mingle, and would not want to pick up the wrong bottle or glass.

Another venue that would profit from the current invention would be any gathering of children, particularly a play group or birthday party. Children forget about their drinks in the excitement of play, then want them again when they get thirsty. The invention would help hosts or care givers determine which drink belongs to which child. Caregivers at a daycare could easily identify a child's bottle, sippy cup or beverage by the band including having the child's name or identifying insignia on the band. School children could easily identify their own bottle of water or beverage by using the band.

Other venues include sporting events and practices, where the athletes are repeatedly setting down and retrieving their drinks. This is particularly true for younger players in community or school leagues who have to supply their own drinks and often do so in disposable beverage containers. People exercising at a gym could easily identify their own bottle of water or beverage by having placed their preferred band on their beverage. Children participating in sports or recreation such as baseball, karate or ballet could easily identify their own beverage.

A family who buys beverages and has members who don't finish an entire drink could benefit as well, by using the device to label the beverage to save for later use. This would save money and shopping trips. The family could also use the device when going on trips, to keep drinks from being confused in the car or on the train or plane, and to try to avoid arguments during the trip.

Preferred embodiments of this invention are illustrated in the accompanying drawings and will be described in more detail herein below.

### SUMMARY OF THE INVENTION

The invention is an article of manufacture comprising a unique identifying device capable of identifying a user's beverage container, in particular, a band having at least one first portion and at least one second portion, the first portion or portions having first and second ends, and the second portion or portions also having first and second ends, wherein the first end of each first portion is connected to the first end of a second portion, and the second end of each second portion is connected to a second end of a second portion.

The invention solves the problem of users' being unable to distinguish their beverage from other users' beverages in a situation where more than one person is or has been present, or where opened beverages are stored for later use. The invention consists of unique bands for use on the outside of glasses, cups, cans, bottles, boxes, cartons or other beverage containers. The uniqueness of the bands is obtained either by manufacturing them with different patterns or writing, including one of each unique pattern or writing per set of devices sold to the consumer, or making them in a set of varying colors, including one of each unique color per set of devices. The band can also be rendered unique by writing on it by hand. The preferred band composition is a stretchable material alternating with another material to form a band, the other material preferably being a material which will accept printing or writing, and most preferably the material is ribbon.

It is an object of the invention to differentiate otherwise identical or similar beverage containers.

It is an object of the invention to promote better health by aiding the prevention of the spreading of germs and diseases through inadvertently shared beverages.

It is an object of the invention to provide an easy, quick, and inexpensive method of differentiating beverage containers.

It is an object of the invention to add a festive atmosphere to a social situation by providing designs for beverage containers.

It is an object of the invention to be able to personalize and/or accessorize beverage containers.

It is an object of the invention to promote sponsorship and advertising by allowing the placement of a logo, advertisement, photo or other promotional item on a band on the outside of a beverage container or on a stirrer to be used in a beverage container.

It is an object of the invention to allow later identification after storage of partially consumed beverages in their original containers.

It is an object of the invention to help a parent or caregiver differentiate their child's juice or beverage box, pouch, bottle or sippy cup from those of other children in any setting where children are grouped together, such as a party, play group or daycare.

It is an object of the invention to avoid quarrels over ownership of a beverage, particularly in situations with children, or with adults who have been consuming alcohol.

### BRIEF DESCRIPTION OF THE DRAWINGS

FIG. 1 is a perspective view of a preferred embodiment of the invention, showing a band that is composed of a portion of stretchable material and a portion of printable material.

FIG. 2 is a perspective view of a preferred embodiment of the invention, showing a unique band with a stretchable material portion and a printable material portion on a beverage bottle.

FIG. 3 is a perspective view of a preferred embodiment of the invention, showing a set of unique bands, each with its own design on the printable portions and each with two stretchable portions alternating with two printable portions.

FIG. 4 is a perspective view of a preferred embodiment of the invention showing a band with two stretchable portions alternating with two printable portions.

FIG. 5 is a perspective view of a preferred embodiment of the invention showing a band with three stretchable portions alternating with three printable portions.

### DESCRIPTION OF THE PREFERRED EMBODIMENTS

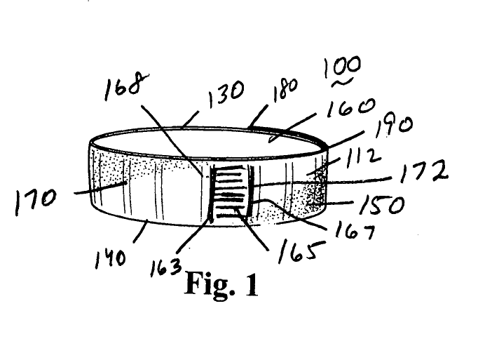

The preferred embodiments of the present invention will now be described with reference to FIGS. 1-5 of the drawings. Identical elements in the various figures are identified with the same reference numerals.

The invention includes identifiers for both re-usable containers such as glasses and cups, and disposable containers such as bottles, cans, cartons, boxes and pouches. Containers are differentiated with an identifying component that is added to the container at the time of use and, in the case of disposable containers, may be disposed of with the container. The identifying component can be retained or disposed of when used with re-usable containers, depending on the user's desire. More specifically, multiple uniquely designed bands are used for differentiating between multiple disposable containers.

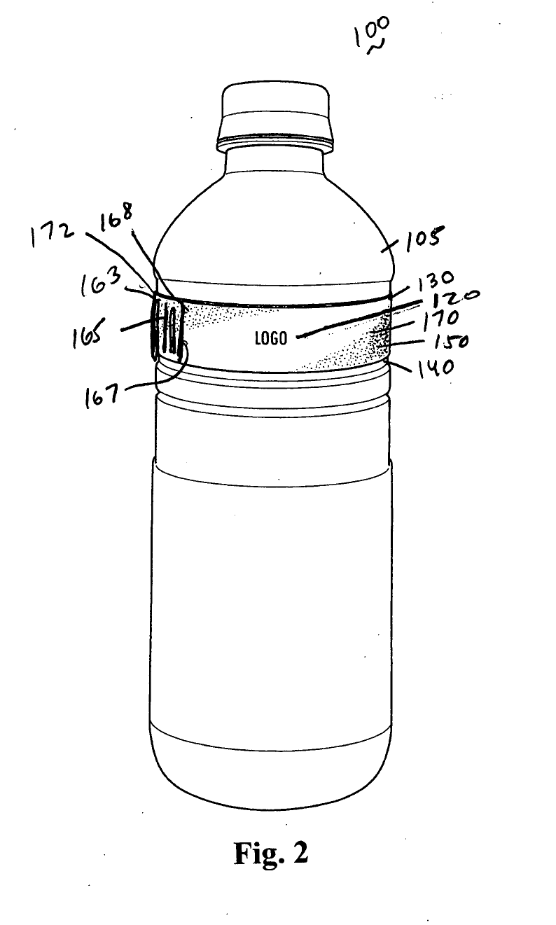

The embodiments shown in FIGS. 1-5 employ a device which is an addition to a beverage container and that allows for differentiation of containers which otherwise would be identical to each other. FIG. 2 demonstrates how the invention can be applied to beverage containers such as bottles. The invention can similarly be applied to cans, boxes or pouches.

The stretchable portions of the band, or the first portions, allow for the band to be stretched for placement on a beverage container, and the second portion or portions are made from other material, preferably material that accepts writing or printing.

A preferred embodiment of this configuration is seen in FIG. 1. The band is composed of alternating portions of stretchable materials and another material. The other material comprising the second portion can be any suitable material, including but not limited to elastic, paper, plastic, spandex, rubber, vinyl, cellophane, cloth, animal skin, cardstock, cardboard, wood, metal, wax, foil, or food. One highly preferred material is ribbon, since it is inexpensive and can be printed or written onto easily.

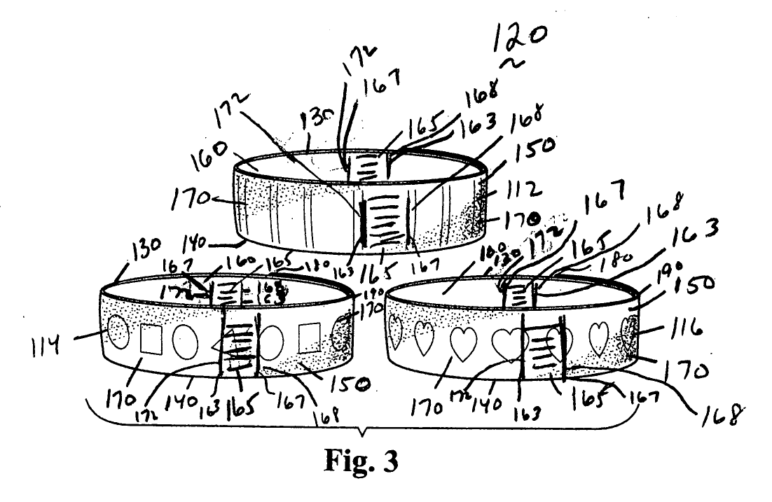

Thus, the configuration of the embodiment described generally in FIG. 1 can comprise multiple configurations. For example, the band could have one portion of stretchable material attached to a single portion of the other material. Or, as seen in FIGS. 3, 4 and 5, the band could comprise 2 or more separate portions of stretchable material and 2 or more portions of the other material. Moreover, if a band is made with more than one stretchable portion, the stretchable portions can be the same or different stretchable material, and portions made from other material can be the same or different materials. For example, a ribbon connected to elastic which is connected to cardboard, or ribbon connected to cardboard connected to elastic connected to other material, and so on.

The dimensions of the embodiment seen in FIG. 1 can be any size or width as appropriate, with preferred dimensions for the ribbon/other material being two 3½″ by 1″ pieces connected by two 1½″ by 1″ pieces of elastic/stretchable material. Both the ribbon/material and the elastic/stretchable material can have variable lengths and widths. Thus, for example, the first portion or portions can be flush with the second portion or portions, or they can independently be of differing widths. The same is true with the lengths, with each portion having the same or independently different lengths.

The first and second portion or portions can be attached together using any suitable method, including but not limited to, gluing, sewing or stapling, or one or more fasteners using mechanical fasteners, such as snaps, rivets, buttons, etc.

The band may be any width or length, with a preferred width of 1 inch and a preferred length of 7 inches, and may wrap around the bottle any number of times or any fraction of one time. It is preferred to be constructed to slip over the bottle as one continuous loop or to be wrapped around and fastened to itself or to the bottle by an adhesive or other closure method. It may also be of any geometrical shape, including a rectangular strip as shown, rectangular with the top or bottom or both edges serrated, or any geometric shape including but not limited to a triangle, star, square, polygon, circle or combination thereof, including multiple repeats of shapes. The band may be disposable or re-useable.

The placement of designs, wherein the term “designs” means patterns, photos, personalizations, logos, jokes, or any writing, on the band may employ, but is not limited to, the following methods: having designs printed on the band, having bands made with the designs as an integral part of the manufacture process, hand-drawing designs on the band, having the designs cut out of the band by die-cutting or other cutting methods, or having design stickers placed on the band. The designs may be placed on any fraction of the band or on the entire band. In a preferred embodiment, the designs may be placed on the outside of the band. Also, designs may be placed on the inside of the band, either alternatively or in conjunction with designs on the outside of the band. For instance, in the case of a joke or trivia question, the question may be printed on the outside of the band and the answer on the inside of the band.

The preferred band materials are one stretchable material, such as the elastane, material and one material that can be printed on rigid material, such as ribbon, but it may be made of any suitable material, including but not limited to elastic, paper, plastic, spandex, elastane, rubber, vinyl, cellophane, cloth, animal skin, cardstock, cardboard, wood, metal, wax, foil, or food. The band may be one continuous material or may be made of one or more portions of a stretchable material, such as an elastane, alternating with the aforementioned materials.

The bands may be differentiated from each other by using different patterns, logos, photos, jokes, personalizations or writings in a set of bands, or by using different colors for otherwise identical bands in a set. Especially preferred are designs promoting or advertising products or companies.

FIG. 1 illustrates a unique identifying device that is a band 100 with an optional pattern 112. The band has a top edge 130, a bottom edge 140, an outside surface 150, an inside surface 160, a stretchable material section 165, a second portion that may or may not be stretchable but is capable of receiving writing 170, band end one 180, and band end two 190. FIG. 1 also illustrates a stretchable portion first end 163, a stretchable portion second end 167, a second portion first end 168, and a second portion second end 172.

FIG. 2 illustrates another embodiment of the invention, the unique identifying device that is a band 100 on a beverage bottle 105. FIG. 2 shows a band that has a logo 120 which can be customized to allow differentiation of multiple bottles or used to advertise or promote a product or service. The band has a top edge 130, a bottom edge 140, and an outside surface 150. The band has a stretchable material portion 165 and a second portion 170 engineered to receive writing, printing or an adhesive, including but not limited to a pattern, logo, photo, joke, or any kind of personalization or adhesive sticker. FIG. 2 also illustrates a stretchable portion first end 163, a stretchable portion second end 167, a second portion first end 168, and a second portion second end 172. The portion 170 can encompass the entire band or any part or parts of the band. A set of bands may contain the same writing or printing but be differentiated by band color.

FIG. 3 illustrates a unique identifying device that is a set of bands 120, each with a different pattern. One band has a line pattern 112, one has a geometric shapes pattern 114, and one has a heart pattern 116. The bands have a top edge 130, a bottom edge 140, an outside surface 150, an inside surface 160, two stretchable material portions 165, two second portions capable of receiving writing, printing, or an adhesive, such as a pattern, logo, photo, joke, personalization or adhesive sticker 170, band end one 180, and band end two 190. FIG. 3 also illustrates two stretchable portion first ends 163, two stretchable portion second ends 167, two second portion first ends 168, and two second portion second ends 172. The band ends may be overlapped any number of times and adhered to each other, or the band ends may be adhered to the container directly. The entire band may also be adhered to the beverage container directly.

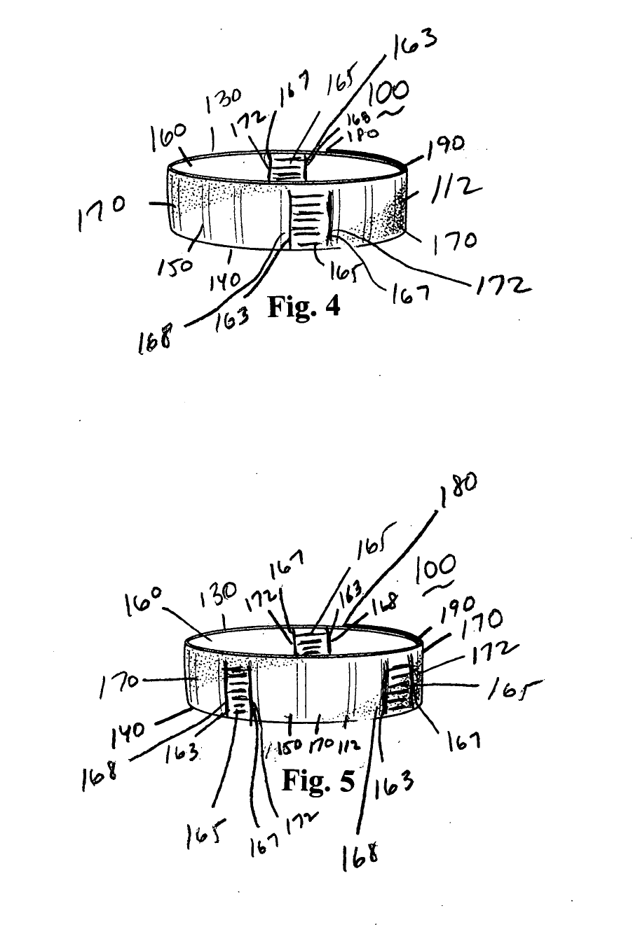

FIG. 4 illustrates a unique identifying device that is a band 100, with an optional pattern 112. The band has a top edge 130, a bottom edge 140, an outside surface 150, an inside surface 160, two stretchable material portions 165, two second portions capable of receiving writing, printing, or an adhesive, such as a pattern, logo, photo, joke, personalization or adhesive sticker 170, band end one 180, and band end two 190. FIG. 4 also illustrates two stretchable portion first ends 163, two stretchable portion second ends 167, two second portion first ends 168, and two second portion second ends 172. The band ends may be overlapped any number of times and adhered to each other, or the band ends may be adhered to the container directly. The entire band may also be adhered to the beverage container directly.

FIG. 5 illustrates a unique identifying device that is a band 100, with an optional pattern 112. The band has a top edge 130, a bottom edge 140, an outside surface 150, an inside surface 160, three stretchable material portions 165, three second portions capable of receiving writing, printing, or an adhesive, such as a pattern, logo, photo, joke, personalization or adhesive sticker 170, band end one 180, and band end two 190. FIG. 4 also illustrates three stretchable portion first ends 163, three stretchable portion second ends 167, three second portion first ends 168, and three second portion second ends 172. The band ends may be overlapped any number of times and adhered to each other, or the band ends may be adhered to the container directly. The entire band may also be adhered to the beverage container directly.

Although this invention has been described with a certain degree of particularity, it is to be understood that the present disclosure has been made only by way of illustration and that numerous changes in the details of construction and arrangement of parts may be resorted to without departing from the spirit and the scope of the invention.

We claim:

1. An article of manufacture, comprising:
A band having at least one first portion and at least one second portion; the first portion or portions having first and second ends, and the second portion or portions also having first and second ends;
wherein the first end of each first portion is connected to the first end of a second portion, and the second end of each second portion is connected to a second end of a second portion.

2. The article of claim 1, wherein the first portion is a stretchable material.

3. The article of claim 1, wherein the second portion is a material that may receive printing or writing.

4. The article of claim 1, wherein the second portion is ribbon.

5. The article of claim 1, wherein the first and second portions are connected using a staple.

6. The article of claim 1, wherein the band has two first portions and two second portions.

7. The article of claim 6, wherein the first portion is a stretchable material.

8. The article of claim 6, wherein the second portion is a material that may receive printing or writing.

9. The article of claim 6, wherein the second portion is ribbon.

10. The article of claim 6, wherein the first and second portions are connected using a staple.

11. The article of claim 1, wherein the unique band is selected from a set comprising at least two bands.

12. The article of claim 1, wherein each band in the set of at least two bands is a different color.

13. The article of claim 1, wherein the second portion has an advertisement.

14. The article of claim 1, wherein the second portion is made from elastic, paper, plastic, lycra, spandex, vinyl, elastane, rubber or cellophane.

15. The article of claim 1, wherein the band has a photo.

16. The article of claim 1, wherein the band is personalized.

17. The article of claim 1, wherein the band has a logo or a joke.

18. The article of claim 1, wherein the unique band is disposable.

19. The article of claim 11, wherein the band has a pattern.
